(19) United States
(12) Patent Application Publication
(10) Pub. No.: US 2026/0067643 A1
(43) Pub. Date: Mar. 5, 2026

(54) BLUETOOTH SMART MATRIX

(71) Applicant: Gentex Corporation, Zeeland, MI (US)

(72) Inventors: Robert Steel, Stratford-upon-Avon (GB); Joshua Michael Close, Binley (GB)

(73) Assignee: Gentex Corporation, Zeeland, MI (US)

(21) Appl. No.: 19/311,541

(22) Filed: Aug. 27, 2025

Related U.S. Application Data
(60) Provisional application No. 63/688,489, filed on Aug. 29, 2024.

(51) Int. Cl. H04W 4/029; B60R 1/04; B60R 1/12; H04W 4/80

(52) U.S. Cl. CPC H04W 4/029; B60R 1/04; B60R 1/12; H04W 4/80; B60R 2001/1284

(57) ABSTRACT

A vehicle including a system for obtaining location information of the vehicle includes a plurality of tracking modules, each configured to emit a location information signal. A first component of the vehicle is a rearview mirror assembly that includes a first one of the tracking modules, a second component includes a second one of the tracking modules, and a third component includes a third one of the tracking modules. A control system is in operable communication with the plurality of tracking modules. The control system is configured to determine that one of the first, second, or third one of the plurality of tracking modules has been removed from a threshold distance from the vehicle or has become inoperable, and generate a signal to one of the first, second, or third one of the plurality of tracking modules that are in the vehicle and operable to emit the location information signal.

### CROSS-REFERENCE TO RELATED APPLICATION

This application claims priority to and the benefit under 35 U.S.C. § 119(e) of U.S. Provisional Application No. 63/688,489, filed on Aug. 29, 2024, entitled “BLUETOOTH SMART MATRIX,” the disclosure of which is hereby incorporated herein by reference in its entirety.

### FIELD OF THE DISCLOSURE

The present disclosure generally relates to a system for obtaining location information of a vehicle. The system includes a plurality of tracking modules configured to emit a location information signal.

### SUMMARY OF THE DISCLOSURE

According to an aspect of the present disclosure, a vehicle including a system for obtaining location information of the vehicle includes a plurality of tracking modules, each configured to emit a location information signal. A first component of the vehicle is a rearview mirror assembly that includes a first one of the plurality of tracking modules, a second component of the vehicle includes a second one of the plurality of tracking modules, and a third component of the vehicle includes a third one of the plurality of tracking modules. A control system is in operable communication with the plurality of tracking modules. The control system is configured to determine that one of the first, second, or third one of the plurality of tracking modules has been removed from a threshold distance from the vehicle or has become inoperable, and generates a signal to one of the first, second, or third one of the plurality of tracking modules that are still in the vehicle and operable to emit the location information signal.

According to another aspect, a vehicle including a system for obtaining location information of the vehicle includes at least two tracking modules, each configured to emit a location information signal. A plurality of different components of the vehicle each includes one of the at least two tracking modules. A control system is in operable communication with the plurality of tracking modules. The control system is configured to determine that one of the at least two tracking modules has been removed from a threshold distance from the vehicle or has become inoperable, and generates a signal to one of the remaining tracking modules that are still in the vehicle and operable to emit the location information signal.

According to still another aspect of the present disclosure, a system for obtaining location information of a vehicle includes a plurality of tracking modules. The plurality of tracking modules are configured to be located in a plurality of different components of the vehicle. At least one, but not all, of the plurality of tracking modules are initially designated to emit a location information signal. A control system is configured to determine that the designated tracking module has been removed from a threshold distance from the vehicle or has become inoperable, and generate a signal to one of the remaining tracking modules that are still in the vehicle and are operable to emit the location information signal.

The present disclosure generally provides a system for obtaining location information of a vehicle for enhanced security. The system includes a plurality of tracking modules configured to emit a location information signal. In this manner, the system's incorporation of the multiple tracking modules integrated with different components of the vehicle, necessitates that each tracking module needs to be removed or to become inoperable before the vehicle can no longer be tracked. Further, the system may include a control system that determines which select ones of the tracking modules emit location information signals based on one or more scenarios to improve operational efficiency.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a side view of a vehicle incorporating a system for obtaining location information of a vehicle, the system includes a plurality of tracking modules configured to emit a location information signal, according to an aspect of the disclosure;

FIG. 1B is a front view of a rearview mirror assembly incorporating one of a plurality of tracking modules configured to emit a location information signal, according to an aspect of the disclosure;

FIG. 2 is a schematic view of a plurality of tracking modules configured to emit a location information signal, according to an aspect of the disclosure; and

FIG. 3 is a control system for obtaining location information of a vehicle, according to an aspect of the disclosure.

### DETAILED DESCRIPTION

The present illustrated embodiments reside primarily in combinations of method steps and apparatus components related to a system for obtaining location information of a vehicle, the system includes a plurality of tracking modules configured to emit a location information signal. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

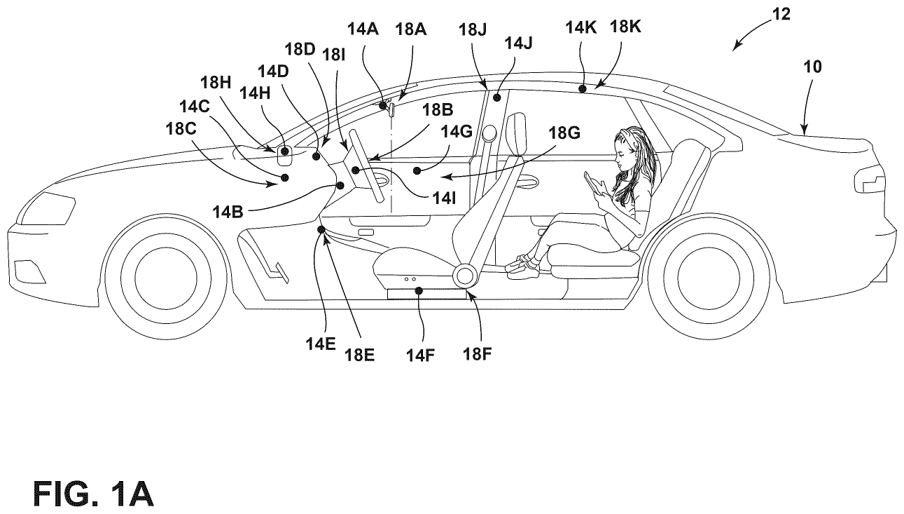

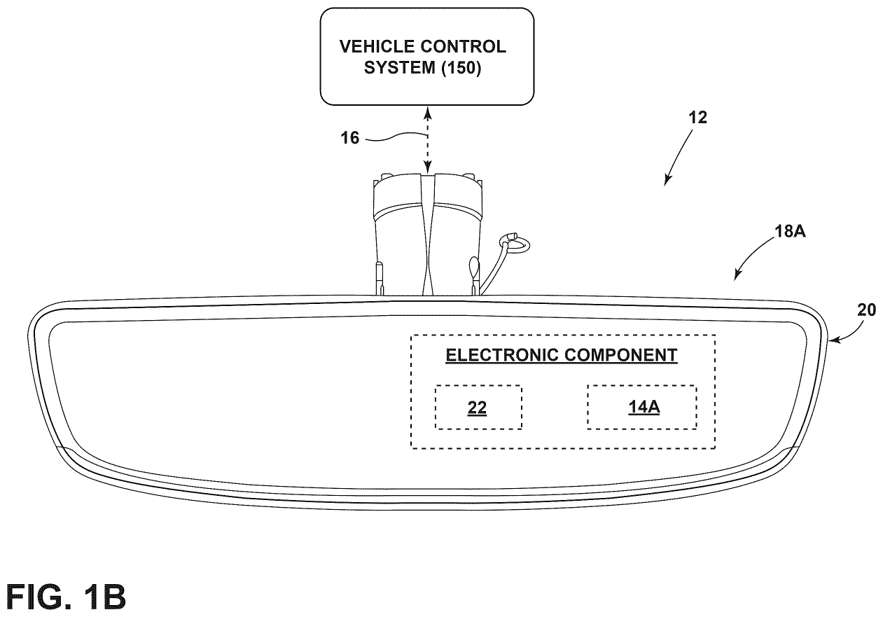

For purposes of description herein, the terms “upper,” “lower,” “right,” “left,” “rear,” “front,” “vertical,” “horizontal,” and derivatives thereof, shall relate to the disclosure as oriented in FIG. 1B. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

Referring to FIGS. 1A-3, reference numeral 10 generally designates a vehicle. The vehicle 10 includes a system 12 for obtaining location information of the vehicle 10 which includes a plurality of tracking modules 14A-14N, each configured to emit a location information signal 16. The plurality of tracking modules 14A-14N is located in various components 18A-18N of the vehicle 10. For example, a first component may be a rearview mirror assembly 18A and may include a first one of the plurality of tracking modules 14A, a second component 18B-18N of the vehicle 10 includes a second one of the plurality of tracking modules 14B, and a third component 18C-18N of the vehicle 10 includes a third one of the plurality of tracking modules 14C. A control system 100 is in operable communication with the plurality of tracking modules 14A-14N. The control system 100 is configured to determine that one of the first, second, or third one of the plurality of tracking modules 14A-14N has been removed from a threshold distance from the vehicle 10 or has become inoperable, and generate a signal to one of the first, second, or third one of the plurality of tracking modules 14A-14N that are still in the vehicle 10 and operable to emit the location information signal 16.

As will be described in greater detail below, the system 12 provides enhanced vehicular security. More particularly, the system's incorporation of the multiple tracking modules 14A-14N integrated with the various components 18A-18N of the vehicle 10, necessitates that each tracking module 14A-14N needs to effectively be removed or to become inoperable before the vehicle 10 can no longer be tracked. Further, as will be appreciated with further reading, the steps carried out by the control system 100 may make the order in which the tracking modules 14A-14N become designated to emit the location information 16 random and difficult to predict, adding an additional layer of tracking capability. The enhanced tracking capabilities of the system 12 are also preventative, as, for example, it becomes more and more impractical to remove each of the tracking modules 14A-14N or cause each of the tracking modules 14A-14N to become inoperable.

With reference now specifically to FIG. 1A, in some embodiments, at least one (e.g., two or more) of the various components 18A-18N may be communicatively coupled with a vehicular control system 150 via, for example, a local interconnect network (“LIN”), a controller area network (“CAN”), and/or the like. In some embodiments, at least one (e.g., two or more) of the various components 18A-18N may receive power from vehicular control system 150 via, for example, a connection with a battery of the vehicle 10. In some embodiments, at least one (e.g., two or more) of the various components 18A-18N may be isolated from the vehicular control system 150. As will be described in greater detail below, the operating principles of the system 12 may be dependent on the components 18A-18N coupling to or isolation from the vehicular control system 150.

The number of components 18A-18N and the number of tracking modules 14A-14N may generally include at least two different components 18A-18N and at least two (e.g., two or more) different tracking modules 14A-14N located in different ones of the at least two components 18A-18N. However, it should be appreciated that the at least two different tracking modules 14A-14N may include at least three tracking modules 14A-14N, at least four tracking modules 14A-14N, at least five tracking modules 14A-14N, at least six tracking modules 14A-14N, at least seven tracking modules 14A-14N, at least eight tracking modules 14A-14N, at least nine tracking modules 14A-14N, at least ten tracking modules 14A-14N, or at least fifteen tracking modules 14A-14N. Regardless of the number of tracking modules 14A-14N utilized, each tracking module 14A-14N may be located in a different one of the components 18A-18N. However, it should be appreciated that two or more of the tracking modules 14A-14N may be located in a singular component 18A-18N as long as, for example, at least one different tracking module 14A-14N is located in a different component 18A-18N.

Still referring to FIG. 1A, the components 18A-18N may include two or more components 18A-18B from a list. While not an exhaustive list, the list may include the first component or rearview mirror assembly 18A, the second component or steering assembly (e.g., steering wheel and/or column) 18B, the third component or an audio module 18C, a fourth component or an infotainment center 18D, a fifth component or a center console 18E, a sixth component or a vehicular seat 18F, a seventh component or a door 18G, an eighth component or a side mirror 18H, a ninth component or an air bag assembly 18I, a tenth component or a pillar 18J, an eleventh component or a body 18K of the vehicle 10 (e.g., between interior trim and the body-in-white), and any other component 18N or additional tracking modules 14A-14N, where “N” represents an unlimited amount of additional designations.

With reference now to FIGS. 1A and 1B, the control system 100 may be configured to initially designate at least one (e.g., one or a number less than all of the number of tracking modules 14A-14N) of the tracking modules 14A-14N to emit the location information signal 16, where the other tracking modules 14A-14N are placed on standby and do not emit the location information signal 16. In this manner, the other tracking modules 14A-14N on standby have lower power requirements until removed from standby. The control system 100 may be further configured to, in response to the initially designated tracking module 14A-14N being removed from the threshold distance from the vehicle 10 or having become inoperable, designate a different one of the plurality of tracking modules 14A-14N to emit the location information signal 16. The initially designated tracking module 14A-14N may be randomized by the control system 100, adding an additional layer of security. The randomized designation may occur once where the designation does not change until removal or inoperability of the associated tracking module 14A-14N or the control system 100 may be configured to randomly designate one of the tracking modules 14A-14N every time the vehicle 10 is started, after a predetermined amount of time or vehicle starts, and/or the like. However, in some implementations, the initially designated tracking module 14A-14N is preselected (e.g., not random) by the control system 100. In some embodiments, the preselected tracking module 14A-14N may include the first tracking module 14A-14N located in the rearview mirror assembly 18A or a different one of the tracking modules 14B-14N. Further, in some implementations, the control system 100 may be configured to randomize or pre-select which of the different one of the plurality of tracking modules 14A-14N are designated in response to the initially designated tracking module 14A-14N being removed from the threshold distance from the vehicle 10 or having become inoperable. The step of designating additional tracking modules 14A-14N may continue for the number of tracking modules 14A-14N available.

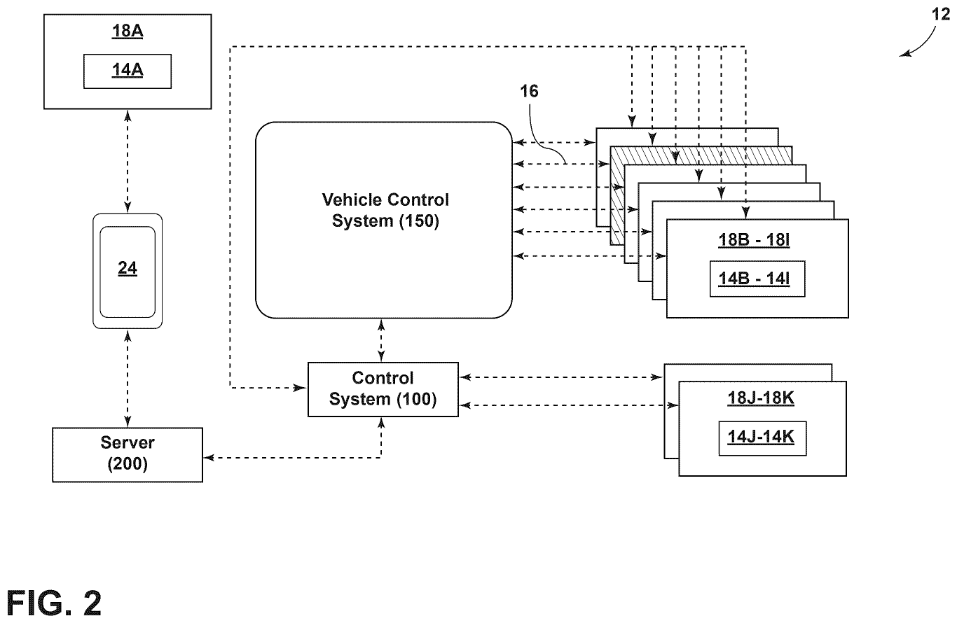

As depicted in FIG. 1B, the rearview mirror assembly 18A illustrates one example communication scheme between the first tracking module 14A and the vehicular control system 150. However, it should be appreciated that, unless explicitly stated, the same principles may be generally applied to the other components 18B-18N and tracking modules 14B-14N. As explained above, the operating principles of the system 12 may be dependent on the components 18A-18N coupling to or isolation from the vehicular control system 150. The rearview mirror assembly 18A may include a variety of electronic components in communication with and/or receiving power from the vehicular control system 150. In some embodiments, at least one of the electronic components may include a communication module (e.g., a short-range or a long-range communication module) configured to be paired with, for example, a mobile phone or other short-range or long-range capable devices 24 (FIG. 2). In some implementations, the control system 100 recognizes the communication module as the first tracking module 14A. In other embodiments the first tracking module 14A is a separate module integrated with the rearview mirror assembly 18A (e.g., located in or otherwise coupled to a common housing 20 and/or power source). Further, in some embodiments, the first tracking module 14A may receive power from an independent power source (e.g., a secondary power source 22) such as a battery designated for the first tracking module 14A and/or for the operation of the rearview mirror assembly 18A.

With reference now to FIG. 2, in operation, if the first tracking module 14A is currently designated to emit the location information signal 16, different triggers can cause the control system 100 to designate a different one of the tracking modules 14B-14N to emit the location information signal 16. For example, if the rearview mirror assembly 18A is in communication with the vehicular control system 150, detachment or destruction (e.g., if the first tracking module 14A becomes inoperable) cause the control system 100 to designate a different one of the tracking modules 14B-14N (e.g., the highlighted tracking module depicted in FIG. 2). If the rearview mirror assembly 18A is in communication with the vehicular control system 150 and detached, but the first tracking module 14A continues to be energized by the secondary power source 22, the first tracking module 14A may be re-designated as a component tracking module 14A associated with the component (e.g., a rearview mirror assembly 18A). For example, the first tracking module 14A may be re-designated as a component tracking module 14A after it has been removed from the threshold distance. During this time, the control system 100 will designate a different one of the tracking modules 14B-14N to emit the location information signal 16 that is associated with the vehicle 10. In this manner, in addition to tracking the vehicle 10, the system 12 may be capable of also tracking the various components 18A-18N when the components or associated tracking modules 14A-14N utilize the secondary power source 22 or the associated tracking modules 14A-14N continue to be operational. Generally speaking, if a component 18A-18N is removed from communication from the vehicular control system 150, the vehicular control system 150 recognizes or detects it as a fault (e.g., a diagnostic trouble code). The detection of the fault may, therefore, facilitate designating a different one of the tracking modules 14B-14N to emit the location information signal 16 and to re-designate the component 18A-18N that has been removed as a component tracking module 14A associated with one of the components 18A-18N.

Many of the components 18A-18N, such as the rearview mirror assembly 18A, the steering wheel or column 18B, the audio module 18C, the infotainment center 18D, the center console 18E, the vehicular seat 18F (e.g., seat controls), the door 18G (e.g., door controls window controls), the side mirror 18H (e.g., defrosting, blind spot detection, etc.), the air bag assembly 18I (e.g., air bag controls/connection), may similarly include electronic components in communication with the vehicular control system 150. These components 18A-18I may also include a communication module that the control system 100 recognizes as one of the tracking modules 14A-14I and/or otherwise may utilize a separate module integrated with the component 18A-18I. In this manner, removal or destruction (e.g., causing inoperability) of the component 18A-18I or the tracking modules 14A-14I can be quickly detected as a fault by the vehicular control system 150. As with the first tracking module 14A, the other tracking modules 14B-14I may receive power from the vehicular control system 150 and/or may include a secondary power source 22 designated for the tracking modules 14B-14I and/or for the operation of the components 18B-18I. When the components 18B-18I or the tracking modules 14B-14I include the secondary power source 22, removal of the components 18B-18I may cause the control system 100 to re-designate the associated tracking modules 14B-14I as component tracking modules 14B-14I (e.g., if the tracking modules 14B-14I have been removed from the threshold distance).

Further, some of the components may not be in communication with the vehicle control system 150. While none of the components 18A-18N and/or tracking modules 14A-14N are required to be in communication with the vehicle control system 150, certain components are more structural in nature and typically do not include electronic components in communication with the vehicle control system 150. For example, the pillar 18J or the body 18K may not include any electronic components and instead include separate tracking modules 14J, 14K integrated with (e.g., connected to and/or located in) the component 18A-18I. The tracking modules 14J, 14K may nonetheless still be in communication with and/or receive power from the vehicle control system 150 (e.g., wired or wirelessly), but are not required to. In some implementations, the tracking modules 14J, 14K and/or other tracking modules 14A-14I that are connected wirelessly to the vehicle control system 150 and rely on the secondary power source 22, the removal of the associated component 18A-18N may not trigger re-designation of that component until it is moved from the vehicle 10 the threshold distance. The threshold distance may be based on physical distance, signal strength, and/or the like.

In some implementations, the location information signal 16 is transmitted over short-range transmission protocols, such as Bluetooth®. In this manner, the designated tracking module 14A-14N essentially functions as a beacon that pairs with or is otherwise received, detected, and recognized by Bluetooth® capable devices (e.g., mobile devices 24). Many of these Bluetooth® capable devices may then transmit that information (e.g., via a cellular network, wireless network, and/or the like) to a network 200 accessible to for example, the owner of the vehicle 10, the manufacturer of the vehicle 10, a security service provider, and/or the like to effectuate tracking the vehicle 10 and, if available, the components 18A-18N.

In operation, the location information signal 16 may provide both proximity-based location and crowdsourced location. More particularly, the proximity-based location determines the location based on the signal strength of the message (e.g., from the designated tracking module 14A-14N). The crowdsource location, on the other hand, enables the designated tracking module 14A-14N to be outside the range of the owner and still be located. The Bluetooth® capable devices (e.g., mobile devices 24) may include other devices in the crowdsourced ecosystem (e.g., Apple® Devices in the Find My Network) that securely relay the location data back to the owner via the server (e.g., network 200), allowing the designated tracking module 14A-14N to be found over long distances. The owner may be the OEM, the owner of the associated vehicle 10, or a provider of the network 200. The location information signal 16 may include a specialty-formed data packet that is broadcast over Bluetooth® low energy (BLE). For example, the location information signal 16 may include device identifier information and power transmission. The device identifier information may change over time for security and privacy, though it remains linked to the same asset via the server (e.g., network 200). The transmission of power specifies the expected signal strength (RSSI) at a reference distance (e.g., usually 1 meter) and can be essential to estimate the distance between the designated tracking module 14A-14N and the device receiving the location information signal 16. More particularly, the device receiving the location information signal 16 compares the actual RSSI with this value to estimate how far away the designated tracking module 14A-14N is from the device receiving the location information signal 16. When more than one device receives the location information signal 16 simultaneously or in quick succession, the location of the information signal (e.g., the tracking module 14A-14N) can be triangulated to a specific location, region, and/or direction of movement.

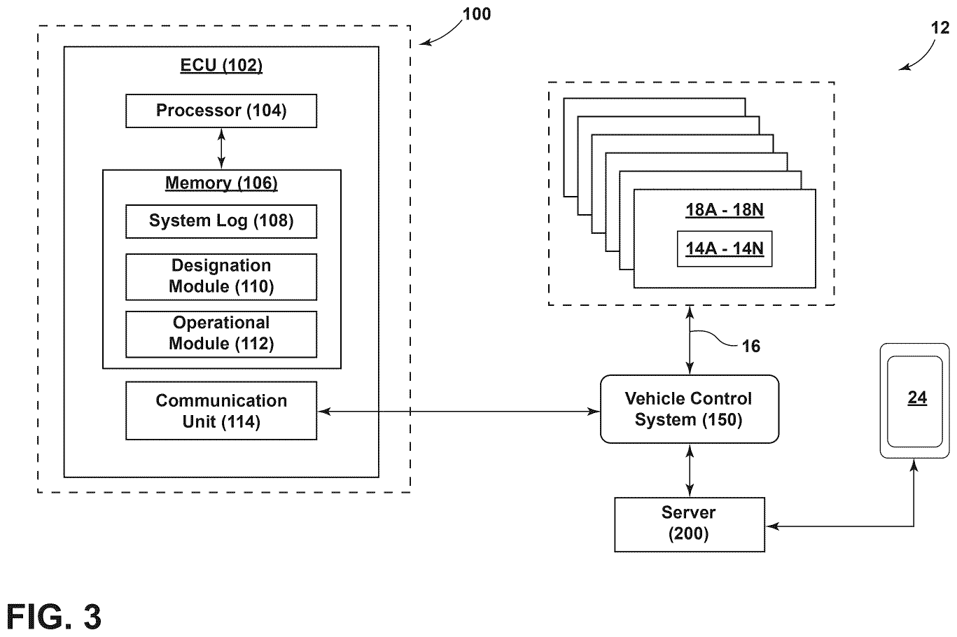

With reference now to FIG. 3, the control system 100 may be partially or fully part of the vehicle control system 150 or otherwise in communication with the vehicle control system 150. Further, the control system 100 may be partially or fully part of the network 200. In some embodiments, the control system 100 is separate from both the vehicle control system 150 and the network (e.g., based on communication and signals between the tracking modules 14A-14N and/or a central hub). In other words, when the control system 100 performs a method or series of operations, each or select operations (e.g., instructions) may be carried out by, the control system 100 itself, the tracking modules 14A-14N and/or a central hub in communication with the tracking modules 14A-14N, the vehicle control system 150, and/or the network.

With continued reference to FIG. 3, the control system 100 may include at least one electronic control unit (ECU) 102. The at least one ECU 102 may be a discrete component specifically tasked with the operations described herein, partially or fully integrated with the vehicle control system 150, or partially or fully integrated with the network 200. The at least one ECU 102 may include the processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the system 12. The tracking modules 14A-14N and the electronic components of the components 18A-18N may, therefore, be controlled by and/or otherwise in communication with the control system 100. The memory 106 may, therefore, include a system log 108 that includes the number of tracking modules 14A-14N, which components 18A-18N are associated with the tracking modules 14A-14N, and which vehicle 10 is associated with the tracking modules 14A-14N. The memory 106 may further include a designation module 110. The designation module 110 may include instructions for preselecting or randomizing the initially designated tracking module 14A-14N. The designation module 110 may further include instructions for preselecting an order for the undesignated tracking modules 14A-14N or for randomizing the order of the undesignated tracking modules 14A-14N when the designated tracking module 14A-14N is moved past the threshold distance and/or becomes inoperable. The control system 100 may further include an operational module 112 that includes instructions for determining if the designated tracking module 14A-14N has been removed from a threshold distance from the vehicle 10 or has become inoperable and performing subsequent actions upon the determination. The control system 100 may further include a communication unit 114 in communication with the tracking modules 14A-14N, the vehicle control system 150, and/or the server 200. In some embodiments, the communication module is a hub in communication with each of the tracking modules 14A-14N and the server 200.

In some implementations, the system 12 for obtaining location information of the vehicle 10 (e.g., the control system 100) may be configured to determine that the designated tracking module 14A-14N has been removed from a threshold distance from the vehicle 10 or has become inoperable (e.g., via the operational module 112). The threshold distance may be associated with a signal strength between the designated tracking module 14A-14N and the vehicle control system 150, a hub, and/or other tracking modules 14A-14N. In response to determining that the designated tracking module 14A-14N has been removed from the threshold distance or has become inoperable, the control system 100 may be configured to perform a subsequent action (e.g., a theft prevention action) via the vehicle control system 150. More particularly, the control system 100 may be configured to prevent starting and operation of the vehicle 10 (e.g., via the vehicle control system 150), generate an alarm at the vehicle 10 (e.g., via the vehicle control system 150), flash headlights of the vehicle 10 (e.g., via the vehicle control system 150), lock the steering wheel 18B (e.g., via the vehicle control system 150), lock the doors (e.g., via the vehicle control system 150), flash heads (e.g., via the vehicle control system 150), continuously beep the horn (e.g., via the vehicle control system 150), power one or more internal or external cameras onboard the vehicle 10 to capture images in and/or around the vehicle 10, the like, and/or combinations thereof. In some implementations, the vehicle control system 150 may perform the subsequent action upon determining that only one tracking module 14B-14N has been removed from the threshold distance or has become inoperable. The other implementations, the vehicle control system 150 may perform the subsequent action upon determining that two, three, or more tracking modules 14B-14N has been removed from the threshold distance or become inoperable.

In some implementations, the subsequent action of the control system 100 may include generating a message to the person/entity who has been designated as responsible. For example, the control system 100 may be configured to, upon determining that the designated tracking module 14A-14N has been removed from the threshold distance or become inoperable, generate a message to notify the person/entity who has been designated responsibility. In implementations where the vehicle control system 150 is configured to perform the subsequent action, the message may require a subsequent action by the person/entity who has been designated responsibility. For example, the message may require that person/entity confirm (e.g., via a designated mobile device and/or other computing device) to disengage the subsequent action via the vehicle control system 150 (e.g., turn off the alarm, allow starting of the vehicle 10, etc.). In some implementations, the subsequent action by the person/entity may include requiring the person/entity to move a key fob within a threshold distance of the vehicle 10. In some implementations, the subsequent action by the person/entity may include requiring the person/entity to use one or more cameras on the vehicle to submit a biometric reading (e.g., an image of the user's face, a fingerprint, and/or the like). In some implementations, the message may provide options to a person/entity to select and/or authorize one or more of the subsequent actions by the vehicle controls system 150 described herein. In some implementations, the subsequent action by the person/entity may be generated on a message of an internal display in the vehicle 10 (e.g., on a display in the rearview mirror assembly 18A, the infotainment center 18D, the center console 18E, etc.) in addition to or alternatively from sending a message to via a designated mobile device and/or other computing device.

It should be appreciated that regardless of any subsequent action requirements by the control system 100 or the person/entity who has been designated responsibility, the control system 100 may be configured to designate subsequent tracking modules 14B-14N as described herein.

The disclosure herein is further summarized in the following paragraphs and is further characterized by combinations of any and all of the various aspects described therein.

According to one aspect of the present disclosure, a vehicle including a system for obtaining location information of the vehicle includes a plurality of tracking modules, each configured to emit a location information signal. A first component of the vehicle is a rearview mirror assembly that includes a first one of the plurality of tracking modules, a second component of the vehicle includes a second one of the plurality of tracking modules, and a third component of the vehicle includes a third one of the plurality of tracking modules. A control system is in operable communication with the plurality of tracking modules. The control system is configured to determine that one of the first, second, or third one of the plurality of tracking modules has been removed from a threshold distance from the vehicle or has become inoperable, and generate a signal to one of the first, second, or third one of the plurality of tracking modules that are still in the vehicle and operable to emit the location information signal.

According to another aspect, one of a first, a second, or a third one of a plurality of tracking modules is initially designated as the only one of the plurality of tracking modules that emits the location information signal. A control system is configured to, in response to the initially designated tracking module being removed from the threshold distance from the vehicle or having become inoperable, and designate a different one of the plurality of tracking modules to emit the location information signal.

According to yet another aspect, the initially designated tracking module is the first tracking module located in the rearview mirror assembly.

According to still another aspect, the control system is further configured to randomize which of the different one of the plurality of tracking modules are designated in response to the initially designated tracking module being removed from the threshold distance from the vehicle or having become inoperable.

According to another aspect, the second component of the vehicle is a steering wheel.

According to yet another aspect, the third component of the vehicle is an audio module.

According to still another aspect, a fourth component of the vehicle includes a fourth one of the plurality of tracking modules and a fifth component of the vehicle includes a fifth one of the plurality of tracking modules.

According to another aspect of the present disclosure, a vehicle including a system for obtaining location information of the vehicle includes at least two tracking modules, each configured to emit a location information signal. A plurality of different components of the vehicle each includes one of the at least two tracking modules. A control system is in operable communication with the plurality of tracking modules. The control system is configured to determine that one of the at least two tracking modules has been removed from a threshold distance from the vehicle or has become inoperable, and generate a signal to one of the remaining tracking modules that are still in the vehicle and are operable to emit the location information signal.

According to still another aspect, the at least two tracking modules include more than two tracking modules.

According to another aspect, the at least two tracking modules include at least five tracking modules each located in different ones of the plurality of different components of the vehicle.

According to yet another aspect, one of the tracking modules is initially designated as the only one of the tracking modules that emits the location information signal. The control system is configured to, in response to the initially designated tracking module being removed from the threshold distance from the vehicle or having become inoperable, and designate a different one of the plurality of tracking modules to emit the location information signal.

According to still another aspect, a control system is configured to randomize which of the different one of the more than two tracking modules are designated in response to the initially designated tracking module being removed from the threshold distance from the vehicle or having become inoperable.

According to another aspect, a control system is configured to, if the initially designated tracking module has an independent power source, designate the removed tracking module as a component tracking module, and continue to emit the location information signal from the removed tracking module.

According to still another aspect, a control system is configured to, in response to the initially designated tracking module being removed from the threshold distance from the vehicle or having become inoperable, perform at least one theft prevention action via a vehicle control system.

According to still yet another aspect, a control system is configured to, in response to the initially designated tracking module being removed from the threshold distance from the vehicle or having become inoperable, generate a message to an entity that has been designated responsibility for the vehicle.

According to yet another aspect, a location information signal is transmitted over Bluetooth®.

According to another aspect, one of the two or more tracking modules is located in an airbag assembly.

According to still another aspect of the present disclosure, a system for obtaining location information of a vehicle includes a plurality of tracking modules. The plurality of tracking modules are configured to be located in a plurality of different components of the vehicle. At least one, but not all, of the plurality of tracking modules are initially designated to emit a location information signal. A control system is configured to determine that the designated tracking module has been removed from a threshold distance from the vehicle or has become inoperable, and generate a signal to one of the remaining tracking modules that are still in the vehicle and are operable to emit the location information signal.

According to another aspect, the location information signal is configured to be transmitted over Bluetooth® to third-party Bluetooth® capable devices that, in response to receiving the location information signal, transmit the location information signal to a network accessible to an entity designated responsible to the vehicle.

According to still another aspect, the location information signal includes identifier information and expected signal strength at a reference distance.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A vehicle including a system for obtaining location information of the vehicle, comprising:
a plurality of tracking modules, each configured to emit a location information signal;
a first component of the vehicle is a rearview mirror assembly that includes a first one of the plurality of tracking modules;
a second component of the vehicle including a second one of the plurality of tracking modules;
a third component of the vehicle including a third one of the plurality of tracking modules; and
a control system in operable communication with the plurality of tracking modules, the control system configured to:
determine that one of the first, second, or third one of the plurality of tracking modules has been removed from a threshold distance from the vehicle or has become inoperable; and
generate a signal to one of the first, second, or third one of the plurality of tracking modules that are still in the vehicle and are operable to emit the location information signal.

2. The vehicle including the system of claim 1, wherein the one of the first, second, or third one of the plurality of tracking modules is initially designated as the only one of the plurality of tracking modules that emits the location information signal, and the control system is further configured to:
in response to the initially designated tracking module being removed from the threshold distance from the vehicle or having become inoperable, designate a different one of the plurality of tracking modules to emit the location information signal.

3. The vehicle including the system of claim 2, wherein the control system is further configured to randomize which of the different one of the plurality of tracking modules are designated in response to the initially designated tracking module being removed from the threshold distance from the vehicle or having become inoperable.

4. The vehicle including the system of claim 2, wherein the initially designated tracking module is the first tracking module located in the rearview mirror assembly.

5. The vehicle including the system of claim 4, wherein the second component of the vehicle is a steering wheel.

6. The vehicle including the system of claim 5, wherein the third component of the vehicle is an audio module.

7. The vehicle including the system claim 1, further including a fourth component of the vehicle including a fourth one of the plurality of tracking modules and a fifth component of the vehicle including a fifth one of the plurality of tracking modules.

8. A vehicle including a system for obtaining location information of the vehicle, comprising:
at least two tracking modules, each configured to emit a location information signal;
a plurality of different components of the vehicle each including one of the at least two tracking modules; and
a control system in operable communication with the plurality of tracking modules, the control system configured to:
determine that one of the at least two tracking modules has been removed from a threshold distance from the vehicle or has become inoperable; and
generate a signal to one of the remaining tracking modules that are still in the vehicle and are operable to emit the location information signal.

9. The vehicle including the system of claim 8, wherein the at least two tracking modules includes more than two tracking modules.

10. The vehicle including the system of claim 9, wherein the at least two tracking modules includes at least five tracking modules each located in different ones of the plurality of different components of the vehicle.

11. The vehicle including the system of claim 9, wherein one of the tracking modules is initially designated as the only one of the tracking modules that emits the location information signal, and the control system is further configured to:
in response to the initially designated tracking module being removed from the threshold distance from the vehicle or having become inoperable, designate a different one of the plurality of tracking modules to emit the location information signal.

12. The vehicle including the system of claim 11, wherein the control system is further configured to randomize which of the different one of the more than two tracking modules are designated in response to the initially designated tracking module being removed from the threshold distance from the vehicle or having become inoperable.

13. The vehicle including the system of claim 11, wherein the control system is further configured to:
if the initially designated tracking module has an independent power source, designate the removed tracking module as a component tracking module; and
continue to emit the location information signal from the removed tracking module.

14. The vehicle including the system of claim 11, wherein the control system is further configured to:
in response to the initially designated tracking module being removed from the threshold distance from the vehicle or having become inoperable, perform at least one theft prevention action via a vehicle control system.

15. The vehicle including the system of claim 11, wherein the control system is further configured to:
in response to the initially designated tracking module being removed from the threshold distance from the vehicle or having become inoperable, generate a message to an entity that has been designated responsibility for the vehicle.

16. The vehicle including the system of claim 8, wherein the location information signal is transmitted over Bluetooth®.

17. The vehicle including the system of claim 8, wherein one of the two or more tracking modules are located in an airbag assembly.

18. A system for obtaining location information of a vehicle, comprising:
a plurality of tracking modules configured to be located in a plurality of different components of the vehicle, at least one but not all of the plurality of tracking modules initially designated to emit a location information signal;
a control system configured to:
determine that the designated tracking module has been removed from a threshold distance from the vehicle or has become inoperable; and
generate a signal to one of the remaining tracking modules that are still in the vehicle and are operable to emit the location information signal.

19. The system for obtaining location information of a vehicle of claim 18, wherein the location information signal configured to be transmitted over Bluetooth® to third-party Bluetooth® capable devices that, in response to receiving the location information signal, transmit the location information signal to a network accessible to an entity designated responsible to the vehicle.

20. The system for obtaining location information of a vehicle of claim 19, wherein the location information signal includes identifier information and expected signal strength at a reference distance.
